(19) United States
(12) Patent Application Publication
(10) Pub. No.: US 2005/0121490 A1
(43) Pub. Date: Jun. 9, 2005

(54) NAIL MAGAZINE

(75) Inventor: Pei-Chang Sun, Taichung (TW)

Correspondence Address: BACON & THOMAS, PLLC, 625 SLATERS LANE, FOURTH FLOOR, ALEXANDRIA, VA, 22314, US

(73) Assignees: MODERN PIONEER LTD., TAICHUNG CITY (TW); SUN, Pei-Chang, TAICHUNG (TW)

(21) Appl. No.: 10/755,369

(22) Filed: Jan. 13, 2004

(30) Foreign Application Priority Data
Dec. 5, 2003 (CN) 200320126483.7

(51) Int. Cl. B25C 5/06

(52) U.S. Cl. 227/120

(57) ABSTRACT

A nail magazine for use in a nailing gun equipped with a firing pin having a fixed stroke includes a nailing seat having a nail slot for the passing of nails and a guide groove for guiding reciprocating motion of the firing pin of the nailing gun. A striking block is positioned in the guide groove of the nailing seat and movable along the guide groove between a standby position and a striking position where the striking block is forced by the firing pin to drive one of the nails out of the guide groove.

### BACKGROUND OF THE INVENTION

1. Field of the Invention

The present invention relates generally to a nail magazine and, more particularly, to such a nail magazine that is suitable for use in a nailing gun equipped with a firing pin having a fixed stroke.

2. Description of the Related Art

A nailing gun is mainly comprised of a gun body with a firing mechanism, and a nail magazine adapted to accommodate nails. The nail magazine comprises a nailing seat connectable to the gun body of the nailing gun. The nailing seat has a nail slot for the passing of the nails, and a vertical guide groove adapted to guide reciprocating motion of a firing pin of the firing mechanism. Upon each down stroke of the firing pin, a nail is driven out of the nailing seat into a workpiece.

In order to effectively drive nails into the workpiece (for example, wood), the moving distance of the firing pin is fixed subject to the length of the nails to be used, i.e., a nailing gun is designed to use a specific type of nails. Therefore, a nailing gun designed for use with square-shaped nails is not suitable for driving U-shaped nails. On the contrary, a nailing gun designed for use with U-shaped nails is not suitable for driving square-shaped nails. Further, there is known a nailing gun specifically designed for driving insulated nails for fastening wire pipe. This design of nailing gun cannot be used to drive square-shaped nails or U-shaped nails. Therefore, a consumer may have to prepare many different types of nailing guns for use with different nails.

Therefore, it is desirable to provide a nail magazine that eliminates the aforesaid drawback.

### SUMMARY OF THE INVENTION

It is the main object of the present invention to provide a nail magazine, which has a striking block set below the firing pin of a nailing gun and movable between a standby position and a striking position for driving a nail into the workpiece upon each down stroke of the firing pin. Simply by changing the striking block, the nail magazine can accommodate different nails for use with the nailing gun equipped with the firing pin having a fixed stroke.

It is still another object of the present invention to provide a nail magazine, which saves equipment cost.

To achieve these objects of the present invention, the nail magazine for use in a nailing gun equipped with a firing pin having a fixed stroke comprises a magazine body for accommodating nails therein, a nailing seat, a front cover, a nail pusher and a striking block. The nailing seat is fixedly fastened to the magazine body and has a guide groove for guiding reciprocating motion of the firing pin, and a nail slot formed in a lower groove section of the guide groove for the passing of the nails accommodated in the magazine body. The front cover is covered on the nailing seat and defines with the guide groove of the nailing seat a passage for the passing of the firing pin. The nail pusher is mounted inside the magazine body for pushing the nails inside the magazine body toward the nail slot. The striking block is positioned in the guide groove of the nailing seat and movable between a standby position and a striking position where said striking block is forced by the firing pin to drive one of the nails out of the guide groove. Biasing means, such as a spring, provides a biasing force to the striking block for returning the striking block from the striking position to the standby position.

### BRIEF DESCRIPTION OF THE DRAWINGS

FIG. 1 is an exploded view of a nail magazine according to a first preferred embodiment of the present invention.

FIG. 2 is a schematic front view of the nail magazine according to the first preferred embodiment of the present invention, showing the striking block in the standby position.

FIG. 3 is similar to FIG. 2 but showing the striking block moved to the striking position.

FIG. 4 is an exploded view of a nail magazine according to the second preferred embodiment of the present invention.

FIG. 5 is a schematic front view of the nail magazine according to the second preferred embodiment of the present invention, showing the striking block in the standby position.

FIG. 6 is similar to FIG. 5 but showing the striking block moved to the striking position.

FIG. 7 is a schematic drawing showing the use of same stroke of firing pin with different embodiments of nail magazine according to the present invention.

### DETAILED DESCRIPTION OF THE INVENTION

A nail magazine according to the present invention is designed for use in a nailing gun having a firing pin 100 of fixed stroke.

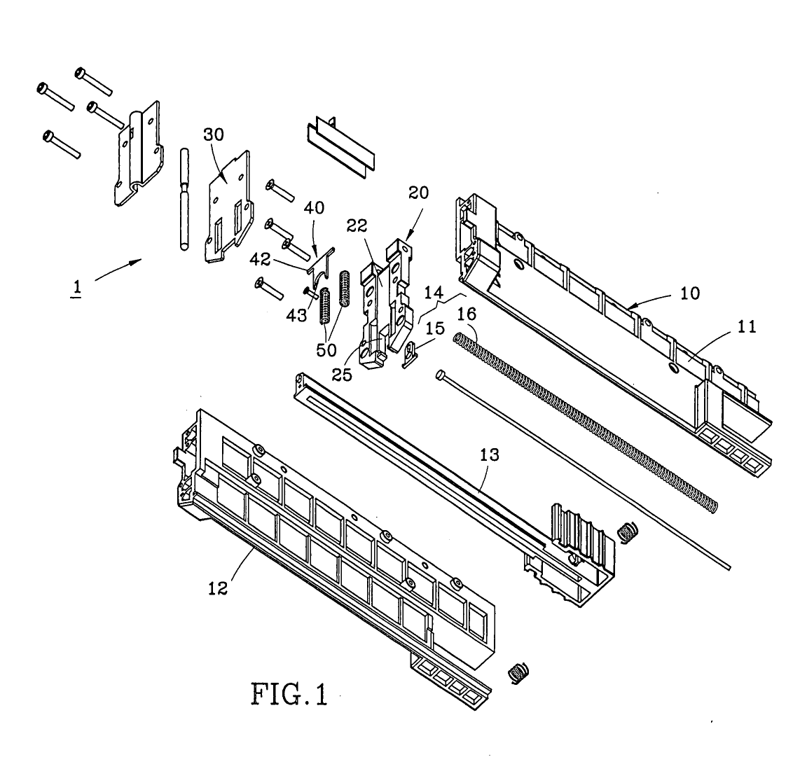

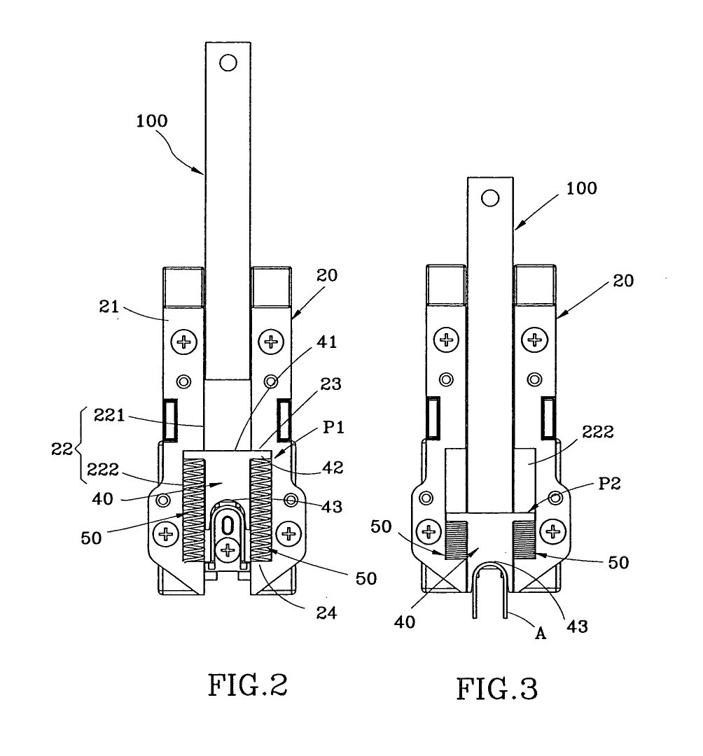

Referring to FIGS. 1 and 2, a nail magazine 1 in accordance with the first preferred embodiment of the present invention is shown comprised of a magazine body 10, a nail pusher 14, a nailing seat 20, a front cover 30, a striking block 40, and biasing means embodied as two spring members 50.

The magazine body 10 is comprised of two symmetrical half shells 11 and 12 and a nail guide 13. According to this embodiment, the nail guide 13 is adapted to carry U-nails A (see FIG. 3). The magazine body 10 is used with the nail pusher 14. The nail pusher 14 is comprised of a push member 15 and a follower spring 16, and adapted to push nails forwardly toward the nailing seat 20. Because the magazine body 10 and the nail pusher 14 are of the known design, no further detailed description in this regard is necessary.

The main features of the present invention are outlined hereinafter. The nailing seat 20 is fixedly fastened to the front end of the magazine body 10, having a vertical guide groove 22 formed of an upper groove section 221 and a lower groove section 222 in the front side 21. The width of the lower groove section 222 is greater than the upper groove section 221. The nailing seat 20 further comprises an upper shoulder 23 and a lower shoulder 24 respectively disposed at top and bottom ends of the lower groove section 222, and a nail slot 25 formed in the lower groove section 222 of the guide groove 22 for the passing of the aforesaid U-nails A.

The front cover 30 is fastened to the outer (front) side of the nailing seat 20, defining with the vertical guide groove 22 of the nailing seat 20 a firing pin passage (not shown) for the passing of the firing pin 100 of the nailing gun. The striking block 40 and the spring members 50 are set in between the front cover 30 and the nailing seat 20. For easy understanding of the action of the firing pin 100, the front cover 30 is not shown in FIGS. 2 and 3.

The striking block 40 is set in the vertical guide groove 22 of the nailing seat 20, and movable between a standby position P1 (see FIG. 2) and a striking position P2 (see FIG. 3). The top side 41 of the striking block 40 is a flat surface. The striking block 40 has two top projections 42 reversely disposed at two sides in flush with the flat top side 41, as shown in FIG. 2, and suspended in the lower groove section 222. The bottom side 43 of the striking block 40 curves inwards to fit the smoothly arched upper part of the U-nails A.

The biasing means, which is embodied as the two spring members 50, is provided for returning the striking block 40 from the striking position P2 to the standby position P1. As shown in FIG. 2, the spring members 50 are provided at two opposite lateral sides of the striking block 40, each having a top end respectively stopped against the bottom side of each projection 42 and a bottom end stopped against the lower shoulder 24. FIG. 2 shows the extended status of the spring members 50 to force the projections 42 of the striking block 40 against the upper shoulder 23, and the striking block 40 is set in the standby position P1 and kept away from the bottom end of the firing pin 100 at a distance. FIG. 3 shows the striking block 40 forced downwards by the firing pin 100 to the striking position P2, at this time the spring members 50 are compressed, and the bottom side 43 of the striking block 40 drives the U-nail A out of the nailing seat 20, finishing the nailing action. When the firing pin 100 returned to its former position, the spring members 50 are released to push the striking block 40 back to the standby position P1.

Technically, the striking block can be made having a flat bottom side for driving square-shaped nails.

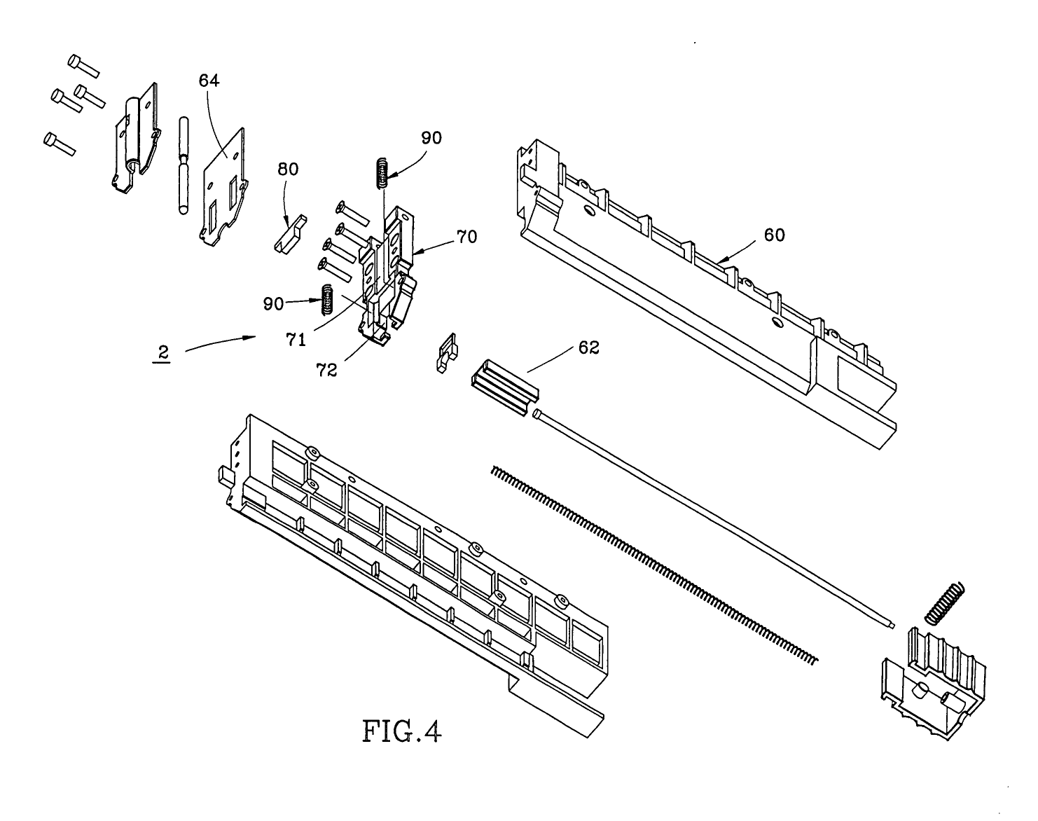

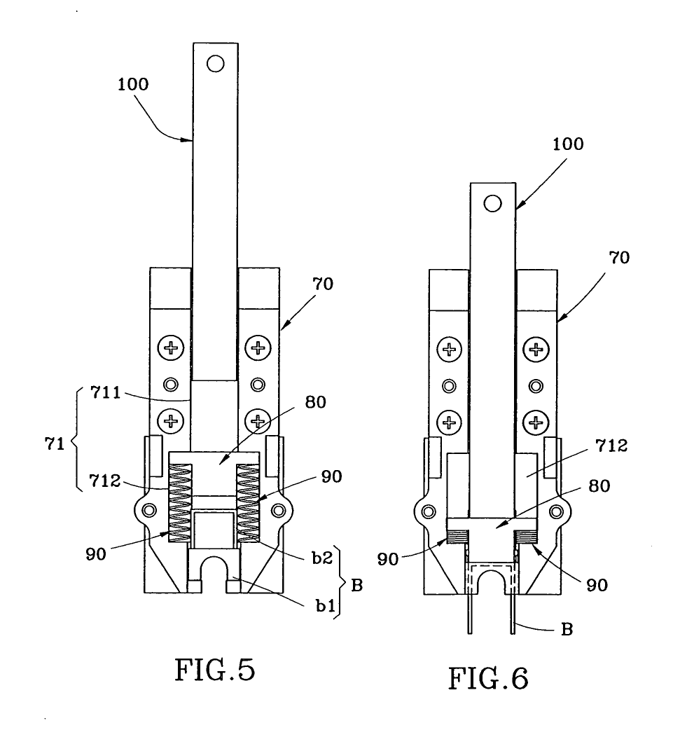

FIGS. 4 and 5 show an alternate form of the nail magazine. According to this embodiment, the nail magazine 2 is adapted to accommodate nails B for holding down wiring pipes. The nails B each comprise an insulator b1 and a metal nail body b2 (see FIG. 5). The nail magazine 2 is comprised of a magazine body 60, a nail pusher 62, a nailing seat 70, a front cover 64, a striking block 80, and two spring members 90. The magazine body 60, the nail pusher 62, and the front cover 64, are not identical to like members in the aforesaid first embodiment of the present invention, however they are of the known art, not within the scope of the improvement of the present invention, and therefore no further detailed description is necessary in this regard.

The main features of the nail magazine 2 are outlined hereinafter. The vertical guide groove 71 of the nailing seat 70 comprises a relatively narrower upper groove section 711 and a relatively wider lower groove section 712. The nail slot 72 is formed in the lower groove section 712 for the passing of the nails B. The striking block 80 and the spring members 90 are set in between the front cover 64 and the nailing seat 70. FIG. 5 shows the status of the nail magazine before firing of the firing pin 100. FIG. 6 shows the firing pin 100 fired and the striking block 80 moved to the striking position.

In either of the aforesaid two embodiments of the present invention, two guide rods (not shown) may be set in the lower groove section of the vertical guide groove of the nailing seat and respectively inserted through the spring members and the two projections of the striking block to guide vertical movement of the striking block in the vertical guide groove of the nailing seat stably.

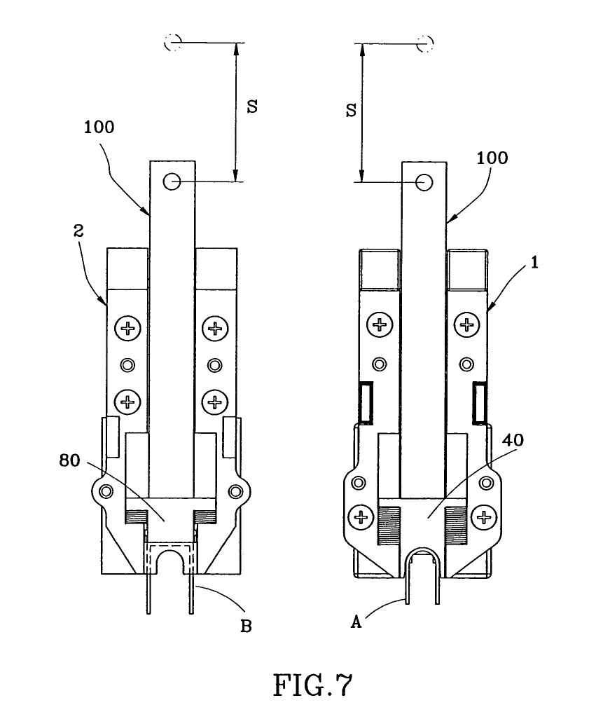

As stated above, the invention sets a striking block below the firing pin and above the striking position to achieve nail striking action upon down stroke of the firing pin. FIG. 7 shows the firing pin 100 has a fixed stroke S, and the nail magazine 1 (for U-nails A) or nail magazine 2 (for wiring pipe binding nails B) installed in the body of the nailing gun. By means of the down stroke to drive the striking block, the nailing action is done, i.e., one nailing gun can be selectively used with different alternate forms of the nail magazine for different nails, saving much equipment cost.

1. A nail magazine for use in a nailing gun equipped with a firing pin having a fixed stroke, the nail magazine comprising:
a magazine body for accommodating nails therein;
a nailing seat fixedly fastened to a front end of said magazine body, said nailing seat having a guide groove vertically extended in a front side thereof, and a nail slot formed in a lower groove section of said guide groove for the passing of the nails accommodated in said magazine body;
a front cover covered on the front side of said nailing seat and defining with said guide groove of said nailing seat a passage for the passing of said firing pin;
a nail pusher mounted inside said magazine body for pushing the nails inside said magazine body toward said nail slot;
a striking block positioned in said guide groove of said nailing seat and movable along said guide groove between a standby position and a striking position where said striking block is forced by said firing pin to drive one of said nails out of said guide groove; and
biasing means for returning said striking block from said striking position to said standby position.

2. The nail magazine as claimed in claim 1, wherein said guide groove of said nailing seat comprises an upper groove section, the lower groove section which is wider than said upper groove section, an upper shoulder at a top side of said lower groove section, and a lower shoulder at a bottom side of said lower groove section; said striking block comprises two projections bilaterally extended from a top side thereof in reversed directions and movably received in said lower groove section; said biasing means comprises two return springs disposed at two opposite lateral sides of said striking block and stopped between the projections of said striking block and said lower shoulder.

3. The nail magazine as claimed in claim 2, wherein said striking block has a flat bottom side for driving square-shaped nails.

4. The nail magazine as claimed in claim 2, wherein said striking block has a bottom side curved inwards for driving U-nails.
